(19) United States
(12) Patent Application Publication
(10) Pub. No.: US 2020/0117910 A1
(43) Pub. Date: Apr. 16, 2020

(54) METHODS AND APPARATUS FOR GENERATING A VIDEO CLIP

(71) Applicant: Thomas Willomitzer, Vienna (AU)

(72) Inventor: Thomas Willomitzer, Vienna (AU)

(21) Appl. No.: 16/161,957

(22) Filed: Oct. 16, 2018

(51) Int. Cl. G06K 9/00; H04N 21/2743; H04N 21/234; G06F 17/30

(52) U.S. Cl. CPC G06K 9/00758; G06K 9/00744; G06F 17/3079; H04N 21/23418; H04N 21/2743

(57) ABSTRACT

The disclosed subject matter relates to methods of generating a clip from a video displayed on a screen, comprising: storing a set of videos in a database of a server, each video containing a sequence of pictures; capturing an image of the screen displaying one of the videos of said set, with a capturing device; transmitting the image, or a fingerprint derived from the image, from the capturing device to the server; in the server, matching the image or fingerprint with at least one of the pictures of one of the videos in the database to determine a matching video and a timestamp of a matching picture in the matching video; and extracting a clip from the matching video, the clip having a length shorter than that of said video and having a start and a stop time in a given relation to said timestamp. The disclosed subject matter further relates to a server and a capturing device to be used in said methods.

### BACKGROUND

### Technical Field

The disclosed subject matter relates to methods of generating a clip from a video displayed on a screen, such as a television set, computer monitor, smartphone etc. The disclosed subject matter further relates to a server and a capturing device to be used in said methods.

### Background Art

To generate video clips from videos displayed on a screen, conventionally a user would either record the screen optically with a camera or use a video recorder electronically connected to the screen. Recording the screen with a camera, for example by directing the camera of a smartphone at the screen, gives poor resolution and leads to moiré, strobe, reflection, and jitter artefacts as well as perspective distortion. Using a video recorder such as a tape, a DVD or a harddisk recorder attached to the screen, or a recording software hosted on a smart TV, computer, or smartphone displaying the video requires dedicated hard- or software and a tedious set-up and configuration. Sharing the video clip may be cumbersome with such conventional techniques.

### BRIEF SUMMARY

It is an object of the present disclosure to provide methods and apparatus for an easy and swift generation of clips from a screen which displays a video, optionally for easy sharing of the clip on the Internet, e.g., on social media websites.

To this end, in a first aspect the disclosed subject matter provides for a method of generating a clip from a video displayed on a screen, comprising:

storing a set of videos in a database of a server, each video containing a sequence of pictures;

capturing an image of the screen displaying one of the videos of said set, with a capturing device;

transmitting the image, or a fingerprint derived from the image, from the capturing device to the server;

in the server, matching the image or fingerprint with at least one of the pictures of one of the videos in the database to determine a matching video and a timestamp of a matching picture in the matching video; and

extracting a clip from the matching video, the clip having a length shorter than that of said video and having a start and a stop time in a given relation to said timestamp.

In this way, an entire clip, e.g., a video scene of up to several seconds or minutes, can be generated from a single image captured of the screen. The capture takes only a moment and is thus neither prone to jitter or movement artefacts from holding a camera by hand for a longer time nor does it require to fiddle with dedicated video recorders. As the video clip is generated by the server from pre-stored videos in its database, these videos can be provided in good or even original quality in the database so that the generated clip does not suffer from low resolution, moiré, jitter, or perspective distortion effects. And as the length, start and stop times of the clip stand in a given relation to the time of capturing the image of the screen, this relation can be tailored to the needs of the user so that the interesting scene of the video is not missed. With conventional recording techniques the user either has to set-up predetermined recording times or may miss the scene when hitting the “record” button too late.

The screen can be any device capable of displaying videos. In a first embodiment, the screen is a television set, the video is broadcast to the television set and the server, and said step of storing comprises recording the broadcast video in the database. The disclosed subject matter then provides an easy-to-use alternative to conventional TV video recorders with the added benefit of being able to share the clip with high quality at ease.

In an alternative embodiment the screen may as well be a computer, the video may be a webcast to that computer, and said step of storing comprises providing the webcast video in the database. The term “computer” as used herein comprises any device capable of displaying computer video files or webcasts, such as desktop, notebook or tablet computers, smartphones, or even smart TVs (which can either be regarded as television sets with added processing capabilities or computers with added television reception capabilities). The disclosed subject matter reduces the processing needs on the side of such computerized screens, i.e., the screen displaying the video does not need to record and store video clips onboard or an attached video recorder. In case of smart TVs, there is no need for adding costly video memory to the smart TV.

The capturing device may be of any known kind suitable to capture an image. In a first variant the capturing device is electronically connected to the screen for electronically capturing the image. This sort of capturing device may, e.g., even be an image capturing application (“app”) hosted as soft- or firmware on a smart TV or smartphone which forms the screen showing the video. Such an app is electronically connected to the internal video feed to the screen display, capturing an image of a picture in the video feed when, e.g., the user pushes a button on the remote control of the smart TV or taps a touch button on the smartphone.

In an alternative second variant, the capturing device is a smartphone with a camera which is directed at the screen for optically capturing the image. This allows for a particular easy and comfortable use. The user just points his/her smartphone at the screen, taps a button, and—in the background, without further user interaction—the image of the screen is captured, uploaded to the server, matched with the correct video currently running on the screen, and the clip is extracted (virtually “recorded”) therefrom. The user may then receive a link to the extracted clip from the server to his/her smartphone, or push/pull the clip from the server to his/her smartphone or another remote device, or share the clip (or a link to the clip) to others via a social media website etc. This all with a video clip of good or even original quality, since the server has stored the video in its database in good or even original quality.

The step of extracting the clip may optionally comprise sending the extracted clip from the server to a remote device, such as the webserver of a social media website. Alternatively, the remote device may be the capturing device itself, e.g., the smartphone with which the user had captured the image of the screen, or the smart TV on the remote control of which the user had hit a “capture” button, or any other capturing device the user had used to capture the image.

According to a further advantageous embodiment of the disclosed subject matter, the step of extracting the clip comprises sending a playlist of uniform resource identifiers (URIs), each URI addressing a different one of subsequent groups of pictures (GOPs) within said clip, from the server to a remote device. This is particularly useful for a large-scale deployment of the disclosed solution in which thousands, hundreds of thousands, or even millions of users utilize the same server for extracting clips. Users may be interested in completely different video scenes and capture images at entirely different times to generate individual clips around individual timestamps. The server would therefore have to extract—and subsequently provide—a very large number of completely different clips, even of the same video. On a large scale this may lead to storage and traffic bottlenecks, e.g., in content delivery networks (CDNs) which deliver the clips to users on smartphones, smart TVs, webservers, or social media websites.

By using playlists of exactly defined (“static”) URIs which each point to only a small “snippet” of the video, e.g., to said GOPs, those snippets can be prepared and cached for all users while the individual user clips need only be defined by those individual playlists. The URIs in the individual playlists take up much less memory space than the video snippets they point to and significantly reduce memory and traffic requirements for their distribution. Concurrently, the pool of snippets, e.g., GOPs of which the clips are composed, is the same for all individual clips so that they can be easily cached in caching proxy servers of today's CDNs. The cached snippets or GOPs need not be retrieved again from the server when already residing in the cashes of the CDN and needed by the same or a different user for another clip containing the same GOPs. The proposed solution is therefore perfectly adapted for scalability in modern CDNs without requiring additional memory or traffic bandwidth.

In a further embodiment of the disclosed methods, the step of extracting the clip may also comprise the step of playing the clip on a screen of the remote device, e.g., the user's smartphone, smart TV or other type of computer, by subsequently retrieving said GOPs from the database via the URIs of said playlist.

The given relation, in which the start and stop times of the extracted clip stand to the timestamp of the video picture matching the captured image, may define a time window preceding that timestamp. Alternatively, the given relation may define a time window into which said timestamp falls. The user thus extracts a video clip around (including) the time of the image capture.

In a further embodiment, the user may “give” this relation by him- or herself, e.g., by pre-defining or editing the start and stop times and hence their relation to the timestamp. To this end, in a further embodiment of the disclosed subject matter the step of extracting the clip comprises, before sending said playlist:

sending a subset of pictures, which are in different time relationship to said timestamp, together with times of said pictures, from the server to the remote device; and

displaying the subset of pictures on a screen of the remote device and selecting the times of two of the pictures of said subset as the start and stop times of the clip.

If the video is encoded in GOPs, the subset may comprise one picture of each GOP, e.g., in the form of a “thumbnail”, displayed to the user on the screen of his/her remote device. The user may then edit the start and stop times of the clip to extract by browsing or scrolling through these pictures (thumbnails) of the subset, and even request additional subset pictures (thumbnails) from the server, to shift the start and stop times even beyond what was initially defined and presented.

The matching of the captured image with one (or more) of the pictures of the videos in the database can be done by any image processing, image recognition, or computer vision technologies. For example, characteristic features (“fingerprints”) of the captured image can be compared to characteristic features of the pictures stored in the database to obtain a match score, and the picture/s with the highest match score/s is/are determined as best match/es.

Such characteristic features or fingerprint of the captured image can, e.g., be already calculated in the capturing device and then transferred with less bandwidth needs to the server. In the server, fingerprints of the pictures can similarly be pre-calculated and stored for each picture or GOP in the database, to lessen computation needs for the later matching with the fingerprint of the image. To further simplify and speed up the matching process, a time of capturing or transmitting the image can be recorded and used for narrowing down the matching of the image (or its fingerprint) with the pictures (or their fingerprints) of the videos in the database. Said time of capturing the image can either be recorded as the instant of capturing or the instant of sending the image (or its fingerprint) to the server or the instant of time of receiving the image in the server. In near-realtime environments with low latency communication networks, all those instants may be close to each other, which is sufficient for the purposes described herein. The search for matching pictures in the videos can then be narrowed down to those pictures whose timestamps are in close vicinity to the recorded time.

In case not only one but several best matching pictures are determined in the matching process, e.g., when—due to image capturing, image recognition, or computer vision inaccuracies—actually the second-to-best matching picture would correspond to the scene of interest of which the user had captured the image, the disclosed subject matter may provide a possibility to select one of those best matching pictures for clip extraction. Hence, in a second aspect, the disclosed subject matter provides for a method of generating a clip from a video displayed on a screen, comprising:

storing a set of videos in a database of a server, each video containing a sequence of pictures;

capturing an image of the screen displaying one of the videos from said set, with a capturing device;

transmitting the image, or a fingerprint derived from the image, from the capturing device to the server;

in the server, matching the image or fingerprint with pictures of the videos in the database to determine a set of matching pictures and a set of timestamps of the matching pictures;

displaying the matching pictures on a screen of the capturing device and selecting one of the matching pictures; and

extracting a clip from that video which contains the selected matching picture, the clip having a length shorter than that of said video and having a start and a stop time in a given relation to the timestamp of the selected matching picture.

Optionally, the step of extracting the clip comprises:

sending a playlist of uniform resource identifiers (URIs), each URI addressing a different one of subsequent groups of pictures (GOPs) within said clip, from the server to the capturing device; and

playing the clip on a screen of the capturing device by subsequently retrieving said GOPs from the database via the URIs of said playlist.

A third aspect of the disclosed subject matter relates to a server configured to:

store a set of videos in a database, each video containing a sequence of pictures,

receive an image, or a fingerprint derived from the image, from a capturing device, the image having been captured from a screen displaying one of the videos from said set,

match the image or fingerprint with at least one of the pictures of one of the videos in the database to determine a matching video and a timestamp of said matching picture in the matching video, and

extract a clip from the matching video, the clip having a length shorter than that of said video and having a start and a stop time in a given relation to said timestamp.

Optionally, the server is further configured to, when extracting the clip,

send a playlist of uniform resource identifiers (URIs), each URI addressing a different one of subsequent groups of pictures (GOPs) within said clip, from the server to a remote device.

A fourth aspect of the disclosed solution provides for a capturing device for generating a clip from a video displayed on a screen, comprising:

a communication interface for communicating with a server which stores a set of videos in a database, each video containing a sequence of pictures;

the capturing device being configured to

capture an image of the screen displaying one of the videos from said set,

transmit the image, or a fingerprint derived from the image, to the server, and

receive a clip from the server, the clip having been extracted from the video by matching the image or fingerprint with at least one of the pictures of one of the videos in the database to determine a matching video and a timestamp of said matching picture in the matching video, the clip having a length shorter than that of said video and having a start and a stop time in a given relation to said timestamp.

Optionally, the capturing device is further configured to, for receiving the clip, first receive a playlist of uniform resource identifiers (URIs), each URI addressing a different one of subsequent groups of pictures (GOPs) within said clip, from the server, and then play the clip on a screen of the capturing device by subsequently retrieving said GOPs via the URIs of said playlist.

Further features and advantages, as well as the structure and operation of various embodiments, are described in detail below with reference to the accompanying drawings.

### BRIEF DESCRIPTION OF THE DRAWINGS/FIGURES

The disclosed subject matter will now be explained in detail by means of exemplary embodiments thereof under reference to the enclosed drawings, in which:

FIG. 1 shows a schematic diagram of a system for carrying out the disclosed method;

FIG. 2 is a sequence diagram of a first embodiment of the disclosed method; and

FIGS. 3a to 3d are sequence diagrams of a second embodiment of the disclosed method, including several optional parts of the method.

Embodiments will now be described with reference to the accompanying drawings.

### DETAILED DESCRIPTION

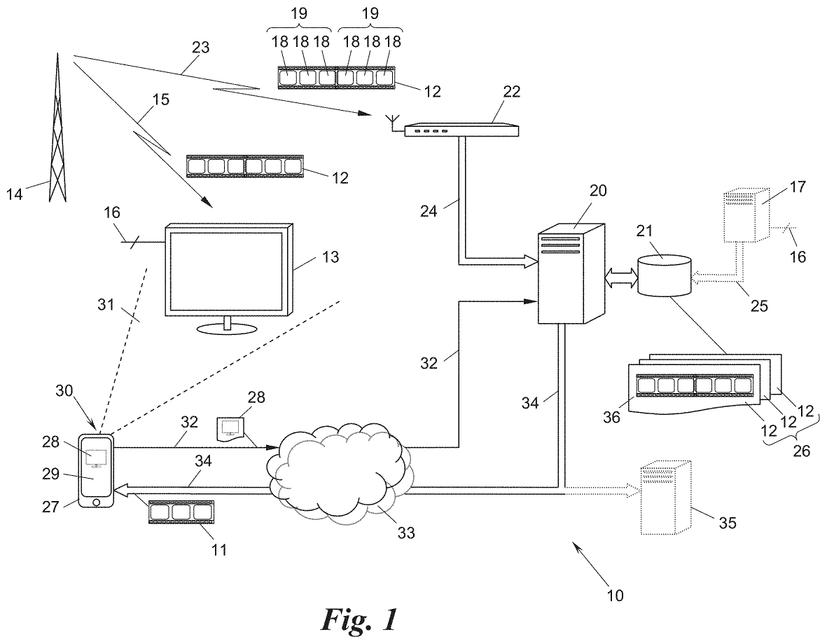

FIG. 1 shows a system 10 for generating clips 11 from videos 12 which are displayed on a screen 13. The screen 13 may be any device capable of displaying videos, e.g., a television (TV) set, a computer with integrated monitor, a monitor attached to a computer, a notebook or tablet computer, a smartphone, or a public display such as an electronic billboard, etc. The videos 12 displayed on the screen 13 may be broadcast “live” from a TV station 14 and received via terrestrial or satellite radio connections 15 at the screen 13. Alternatively, the videos 12 might have been received over an interface 16 from a video player (not shown) or a webserver 17 connected in turn via the interface 16 to the screen 13. For example, the interface 16 may comprise web interfaces and the videos 12 may be pushed or pulled via a communication network such as the Internet to the screen 13 for display.

The videos 12 may be encoded in any currently known or future video coding format, for example according to video data compression standards such MPEG-1, H.262/MPEG-2, H.263/MPEG-4, H.264/MPEG-H, or the like.

Each video 12 comprises a sequence of individual pictures 18. The extracted clip 11 therefore comprises a subsequence, a smaller subset, of those pictures 18. In many of today's video coding standards, the sequence of pictures 18 in the video 12 is divided into subsequent groups of pictures (GOPs) which are compressed independently of each other, i.e., the video 12 contains a sequence of GOPs 19, each GOP 19 containing compressed information on the group of pictures 18 it encodes. For ease of representation, in FIG. 1 two exemplary GOPs 19, each comprising/encoding three exemplary pictures 18, are depicted. It goes without saying that a video 12 may comprise a large number of GOPs 19 and each GOP 19 may comprise any defined number of pictures 18 according to the specific video coding standard employed. For example, in one variant of the MPEG-4 standard there may be 25 pictures 18 in one GOP 19 which yields—at a frame rate of 25 pictures per second—a length of one second for one GOP 19.

While a video 12 is being broadcast (see radio connection 15) to the screen 13 for display, it is concurrently recorded by a server 20 in a database 21 of the server 20. To this end, the server 20 may comprise an own radio receiving equipment 22, such as a terrestrial or satellite television receiver, to receive a live broadcast of the video 12 from the television station 14 via a radio connection 23. The receiver equipment 22 may be connected via a video or data connection 24 to the server 20. Alternatively, if the screen 13 displays a video 12 from a video file received over its interface 16, e.g., a webcast over the Internet, the webcasting server such as the server 17 may directly provide that video 12 to the server 20 for storage in the database 21, see data connection 25. A further possibility is that the videos 12 that the TV station 14 broadcasts are provided by the TV station 14 directly to the server 20 for storage in the database 21. In either case, the system 10 relies on a set 26 of videos 12 stored in the database 21 of the server 20—by whichever means they have been stored in the database 21, be it by recording of live broadcasts, by local storage of video tapes, DVDs etc., or by uploads from a webserver 17 or TV station 14.

To generate the clip 11 from a video 12 which is displayed on the screen 13, the user is provided with a capturing device 27 for capturing an image 28 of the screen 13 currently showing the video 12. In the example of FIG. 1, the capturing device 27 is a smartphone with a screen 29 on its front and a camera 30 on its rear with an angle of view 31 which captures the screen 13 when the camera 30 is directed at the screen 13. The image 28 of the screen 13 may be rectified, de-skewed for perspective distortion, and/or cut to the contents of the screen 13 so that the image 28 as best and straight as possible shows one of the pictures 18 of the video 12 currently displayed on the screen 13. The image 28 may be displayed to the user, e.g., on the screen 29.

The capturing device 27 may alternatively be electronically—wirebound or wireless—connected to the screen 13 to capture the image 28, for example as a separate hardware device or a special software application running on hardware in the screen 13 or a hardware attached to the screen 13. For example, if the screen 13 is a smart TV, the capturing device 27 could be implemented by a capturing application (“app”) running on the processing hardware of the screen 13 to capture the image 28 from “inside” the screen 13. In the same way, when the screen 13 is, e.g., a smartphone, the capturing device 27 may be a software app in the smartphone.

A time “t” of capturing the image 28 may be recorded together with the image 28 or not. This time t is for example the time of which a “capture” button is pressed on a capturing device 27, e.g., a touchscreen button on the screen 29 of the capturing device 27 in the form of smartphone, a “capture” button on a TV remote control of a capturing device 27 in the form of a smart TV app in the screen 13, etc.

The captured image 28 is transmitted from the capturing device 27 to the server 20 via a data connection 32. The data connection 32 may be an Internet connection, possibly also involving one or more intermediate mobile phone networks 33. For example, a capturing device 27 in the form of a smartphone may have a 3G, 4G, 5G, etc. data connection 32 via GSM, GPRS UMTS, LTE, etc. with the server 20.

To save transmission bandwidth on the data connection 32, the image 28 may be compressed for transmission. For example, a set of characteristic features can be derived or calculated from the image 28 in the capturing device 27. Such set of characteristic features of an image 28 is called a “fingerprint” of the image 28.

Next, in the server 20 the image 28 (or its fingerprint) is compared with all the pictures 18 of all videos 12 in the set 26 in the database 21 to find the picture 18 that best matches the image 28 (or its fingerprint). If fingerprints of images 28 are used, for this comparison fingerprints for the pictures 18 in the database 21 could be calculated in the same way. Such fingerprints of the pictures 18 could also be pre-calculated and stored together with the videos 12, for example during recording (23) or providing/uploading (25) of the videos 12 in/into the database 21 to speed up the matching process.

Finding the best matching picture 18 (or its fingerprint) for a given image 28 (or its fingerprint) can be done by any image processing technique known in the art, e.g., by feature extraction and feature comparison, by calculation of match scores, etc. In general, all possible image recognition or computer vision technologies can be used.

Optionally, not only the (“one and only”) best matching picture 18 is determined, but an entire set of n (n>1) best matching pictures 18, as will be explained later. The n best matching pictures 18 can stem from the same or different videos 12 in the database 21.

The time t of capturing the image 28 can be used to narrow down the search for the one or n best matching picture/s 18 of the set 26, if timestamps ts₁, ts₂, . . . , generally tsᵢ, of the pictures 18 are stored in the database 21 which correspond to the display times of the pictures 18 of a video 12 on the screen 13. For example, if the video 12 has been broadcast by the TV station 14 and recorded “live” by the receiving equipment 22 of the server 20 together with current timestamps tsᵢ of each picture 18 (e.g., as a timecode of the video 12 broadcast), only those pictures 18 need to be considered and searched for a match with the image 28 of which the timestamps tsᵢ lie in a certain time range around the time t of the image 28, e.g., within +/−5 seconds. In case of near-realtime systems, e.g., a low latency data connection 32, instead of the capturing time of the image 28 also the time of transmitting the image 28 via the data connection 32 can be used as the time t of an image 28. Such transmitting time t can either be the time of sending the image 28 from the capturing device 27 or the time of receiving the image 28 at the server 20.

When the picture/s 18 that best match/es the received image 28 has/have been determined by the server 20, this means that also the corresponding video/s 12 which contain/s that/those picture/s 18 has/have been determined. The server 20 can now extract the clip 11 from the determined best matching video. If there were more than one best matching video 12, the user is offered an option to select one of those videos 12 as will be explained later on.

To extract the clip 11 from the matching (or subsequently selected) video 12, the server 20 extracts those pictures 18 (or GOPs 19) from the video 12 which have timestamps tsᵢ in a certain time-relation to the timestamp tsₘ of the matching (or subsequently selected) picture 18 of the matching (or subsequently selected) video 12. The extracted clip 11 has usually a length significantly shorter than the length of the video 12, for example a length of 1-30 seconds, as contrasted to a video length of several minutes or hours. The extracted clip 11 has a start time tsₛₜₐᵣₜ corresponding to the timestamp tsᵢ of the first picture 18 in the clip 11, and a stop time tsₛₜₒₚ corresponding to the timestamp tsᵢ of the last picture 18 in the clip 11. If the pictures 18 are compressed into GOPs 19, those timestamps tsᵢ may also be more generalized or “coarser” timestamps tsᵢ of the GOPs 19. The pictures 18 in the clip 11—if not already present in the form of GOPs—can be encoded into GOPs 19 for easier storing, distribution and sharing of the clip 11.

The extracted clip 11 may thus have a perfect “original” quality equal to the original quality of the videos 12 in the database 21, even if the image 28 captured of the screen 13 was of modest quality or resolution. In fact, the quality or resolution of the image 28 only affects the matching process in the server 20 (the reliability of the “best match”) but not the quality of the clip 11. If the videos 12 in the database 21 had, e.g., been recorded with good or original quality via the receiving equipment 22 from video broadcasts or even been provided in original broadcasting or webcasting quality by the TV station 14 or webserver 16 in the database 21, this good or even original quality is retained in the clip 11.

The extracted clip 11 may be sent back from the server 20 to the capturing device 27, e.g., the user's smartphone, for displaying on the screen 29 by means of the data connection 34. The data connection 34 may again involve mobile phone network/s 33, the Internet etc. The clip 11 may, however, additionally or alternatively be sent to another remote device, e.g., a webserver 35 of a social media website, to share the clip 11 online. The user at the capturing device 27 may optionally annotate or mark-up the clip 11 with metadata such as comments, links, or the like for sharing the clip 11 online. Such metadata could also be provided by the server 20 from the originating video 12 itself, e.g., from metadata 36 stored with each video 12 in the database 21. The metadata 36 may, apart from comprising user comments, comprise the capturing time t of the image 28, the TV channel or source of the video 12, a description of its contents, authors, links to further online artistic or commercial information related to the video 12, etc. It should be noted that in the simplest form of the system 10, the extracted clip 11 may not be fed back to the capturing device 27 but only distributed online, e.g., by automatically uploading it to a social media site on the webserver 35 for sharing and commenting.

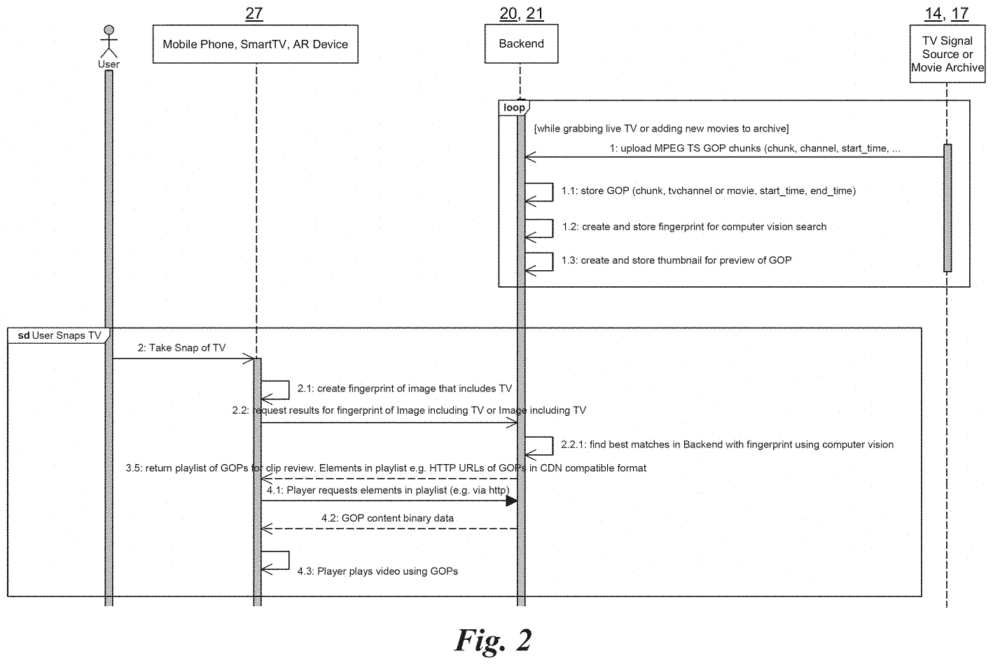

FIG. 2 shows a first embodiment of the clip generation method described with reference to FIG. 1, including an implementation for GOP use in CDNs. In step 1, the video/s 12 is/are recorded, uploaded, or otherwise provided into/in the database 21 to form the set 26. Step 1 may comprise an optional step 1.1 of storing the video/s 12 in form of sequences of GOPs 19, an optional step 1.2 to create and store fingerprints of the pictures 18 or GOPs 19 in the database 21 for each video 12, and an optional step 1.3 of creating and storing lower solution versions (“thumbnails”) of pictures 18 used for later preview purposes. In step 1.3, for example, a picture 18 (or its thumbnail) may be additionally stored in or with respect to a GOP 19 to ease access to the contents of the GOP 19 for preview purposes.

Step 2 shows the capturing of the image 28 of the screen 13 on which one of the videos 12 of the set 26 is currently displayed. In an optional step 2.1 a fingerprint of the image 28 is calculated in the capturing device 27. In step 2.2 the image 28 (or its fingerprint) is sent to the server 20 via the data. connection 32.

In step 2.2.1 the server 20 matches the image 28 (optionally by using its fingerprint) with the pictures 18 (optionally by using their fingerprints) in the database 21 as explained above, to determine the matching video 12 from which the clip 11 is to extract.

Steps 3.5 to 4.3 show a CDN enabled embodiment of distributing the extracted clip 11, here, for displaying it on a remote device such as, e.g., the capturing device 27 which may be in the form of a smartphone. To this end, as one part of the clip extraction process, the server 20 sends a playlist of uniform resource identifiers (URIs) to the remote device which shall display the clip 11, here, the capturing device 27. Each URI addresses one of the GOPs 19 in the clip 11, i.e., one of the GOPs 19 between the start time tsₛₜₐᵣₜ and the stop time tsₛₜₒₚ around the timestamp tsᵢ of the best matching picture 18 in a video 12. The clip 11 is then represented by a sequence of GOPs 19. When the URIs of the GOPs 19 that are contained in the playlist are “static” URIs to web addresses in the database 21 where those GOPs 19 are stored, such static URIs are perfectly suited for caching in CDNs or proxies along the way of the data connection 34, i.e., to cache the GOPs 19 in, e.g., proxy servers of the Internet or mobile phone network/s 33.

The term “uniform resource identifier” (URI) as used herein encompasses all possible embodiments and implementations of such URIs, e.g., uniform resource locators (URLs), persistent uniform resource locators (PURLs), uniform resource names (URNS), digital object identifiers (DOIs), internationalised resource identifiers (IRIs), etc.

The remote device, here, the exemplary capturing device 27, can then play the clip 11 on the screen 29 by subsequently requesting the GOPs 19 via the URIs in the playlist (step 4.1) and retrieving those GOPs 19 (step 4.2). Showing those GOPs 19 seamlessly one after the other (step 4.3) will then display the clip 11 on the screen 29.

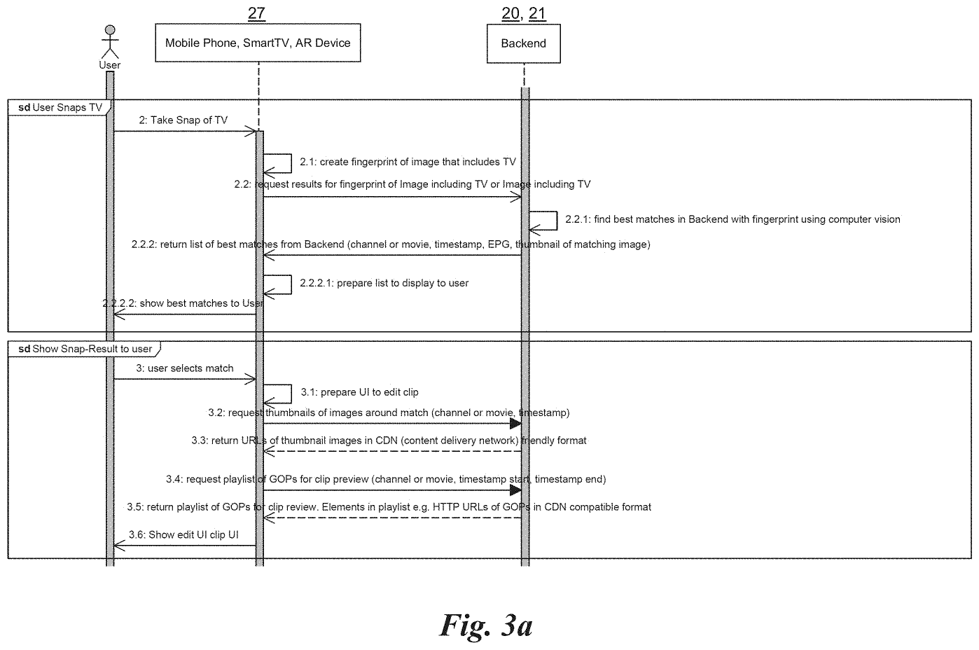

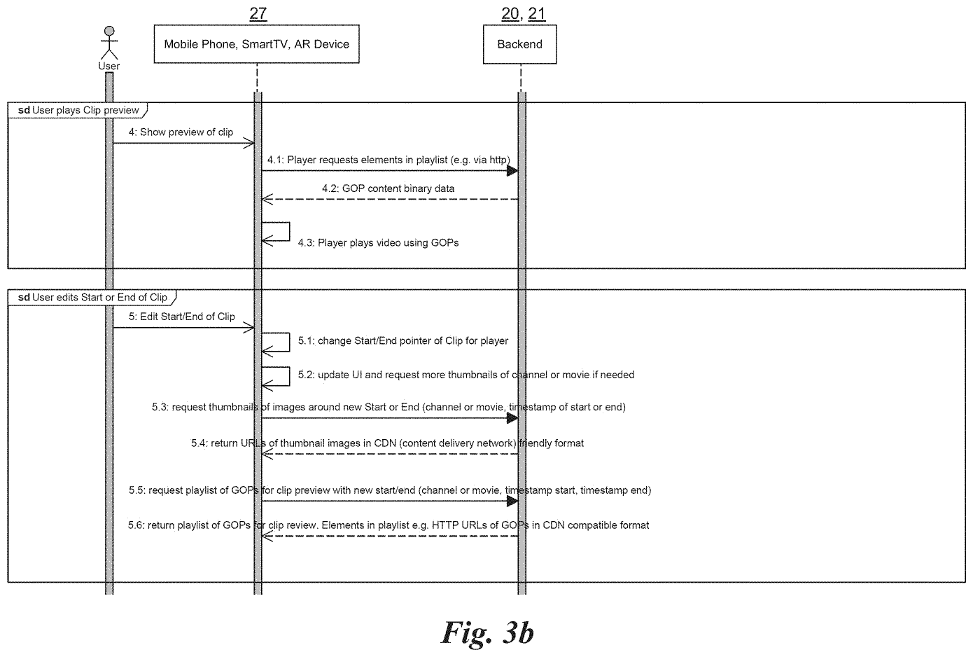

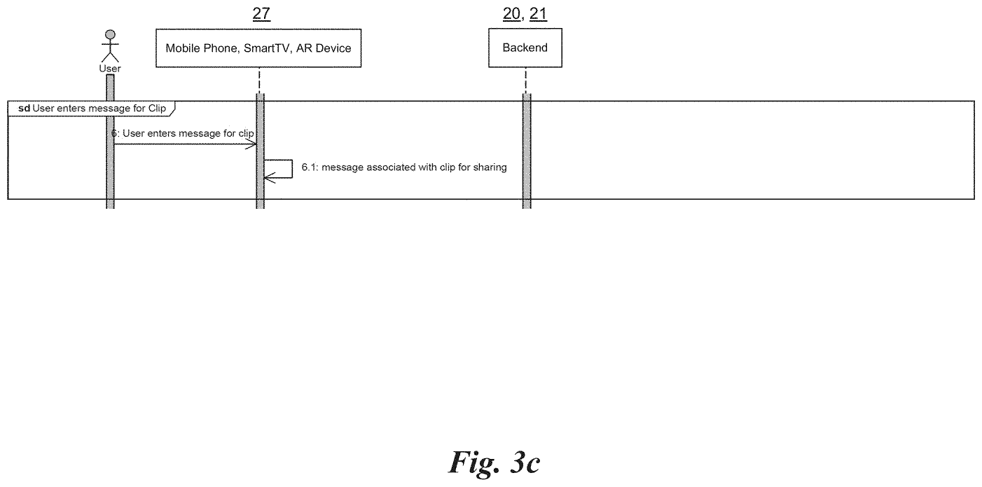

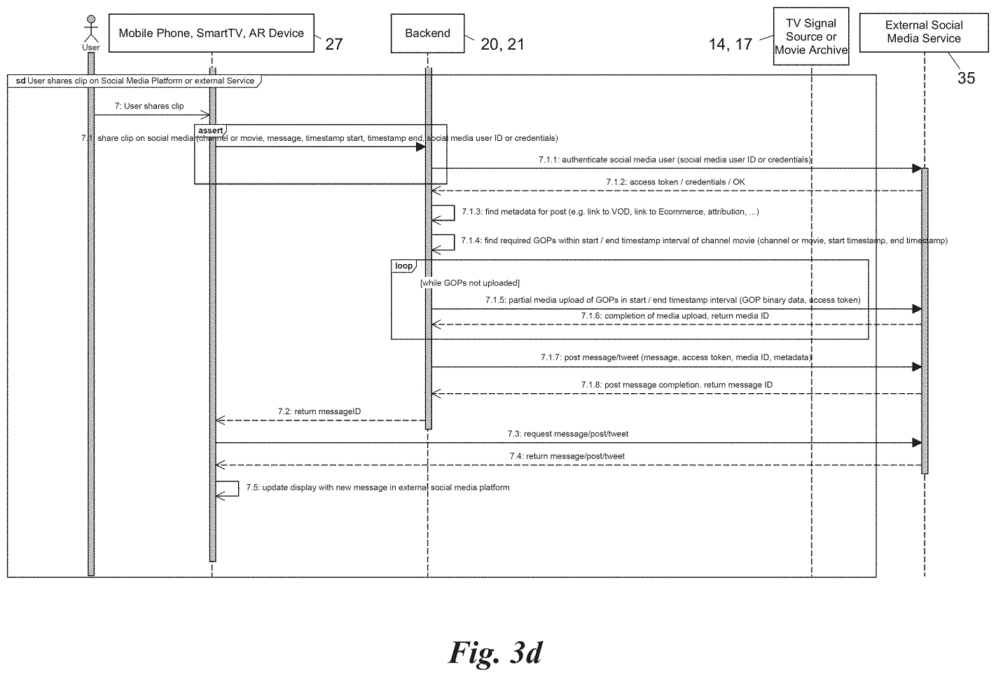

FIGS. 3a to 3d, which are to be read sequentially (the “top” of FIG. 3b, 3c, 3d continuing after the “bottom” of the respective previous FIG. 3a, 3b, 3c), show a second embodiment of the clip generation method described with reference to FIG. 1 with optional further components. The method of FIGS. 3a to 3d does not bring up only one best matching picture 18 or video 12, but a couple of best matching pictures 18 or videos 12 from which the user can select the actual one of interest, for example, if the matching process in step 2.2.1 was not entirely accurate and, e.g., the video 12 with a second-to-best matching score is actually the correct one the user was watching on the screen 13.

In FIGS. 3a to 3d, steps 1 to 2.2 are the same as discussed with reference to FIG. 2, however, step 2.2.1 now returns an entire set of best matching pictures 18. Steps 2.2.2 to 3.1 show an optional selection process for the user. In step 2.2.2, the set of best matching pictures 18 (or their thumbnails) is sent from the server 20 to the capturing device 27, optionally supplemented by metadata such as channel or movie information, timestamps tsᵢ, electronic programming guide (EPG) information, etc. In steps 2.2.1 and 2.2.2 the set of matching pictures 18 (or their thumbnails) is displayed on the screen 29.

In step 3 the user selects the matching picture 18 of interest. In optional steps 3.1, 3.2 and 3.3 the capturing device 27 may request and receive further pictures 18 (or their thumbnails) from the server 20 around the matching picture 18 selected. Upon request (step 3.4), the server 20 returns the playlist of URIs of the GOPs 19 of the clip 11 extracted as in step 3.5 of FIG. 2, and after user interaction in steps 3.6 and 4 the playing of the selected clip 11 happens in steps 4.1, 4.2 and 4.3 as in FIG. 2.

Before or after steps 3.4 to 4.3 the user may change the start and stop times of the clip 11, i.e., edit the given relation of the start and stop times tₛₜₐᵣₜ and tₛₜₒₚ of the clip 11 based on previewing some of the pictures 18 of the clip 11 as defined by the current start and stop times tₛₜₐᵣₜ, tₛₜₒₚ. By means of a user interface (UI) running on the capturing device 27, the user may scroll or browse through a subset of pictures (or their thumbnails) 18 which had been provided from the server 20 to the capturing device 27. The pictures 18 of said browsing or scrolling subset start in different time relationships to the timestamp tsₘ of the best matching picture 18 selected. For example, the browsing subset may comprise one picture (or thumbnail) 18 of each of five GOPs 19 before and one picture or thumbnail 18 of each of five GOPs 19 after that timestamp tsₘ. The UI can also be used to request additional pictures 18 (or thumbnails thereof), see step 5.2 and 5.3.

After presenting those subset of pictures (thumbnails) 18 in step 5 to the user and sending a respective request from the capturing device 27 to the server 20 in step 5.5, the server 20 returns in step 5.6 the playlist of the—now updated, i.e., freshly selected—GOPs 19 which form the clip 11. With this updated playlist the capturing device 27 can then again work through the URIs of the playlist to retrieve the GOPs 19 and display them as the extracted clip 11 on the screen 29, as discussed above with reference to steps 4.1 to 4.3 of FIG. 2.

FIG. 3c shows an optional method section of entering metadata of the extracted clip 11 into the capturing device 27 (steps 6 and 6.1). The metadata can then be used in the optional method section of FIG. 3d for sharing the clip 11 online, e.g., on the webserver 35 of a social media site.

When the user initiates to share the clip 11 (step 7), optionally after having provided metadata as shown in FIG. 3c, a request to share the clip 11 is forwarded from the capturing device (or any other remote device the user is using) to the server 20 (step 7.1). In steps 7.1.1 and 7.1.2 the server 20 opens a connection to the social media webserver 35 and requests and receives an access token, credential, or any other identification or confirmation for a media upload. The server 20 then retrieves the extracted clip 11 and its optional metadata (steps 7.1.3 and 7.1.4) and uploads the clip 11 in form of GOPs 19 under the access token etc. received (steps 7.1.5 and 7.1.6). In steps 7.1.7 and 7.1.8 the server 20 may post further metadata such as TV channel information, timestamps, content information, ecommerce links, user messages, and annotations to the webserver 35. The success of the uploading and posting is notified to the user at the capturing device 27 (step 7.2). In steps 7.3 to 7.5 the user may request or add further messages, posts or tweets for the uploaded clip 11.

### Conclusion

The disclosed subject matter is not restricted to the specific embodiments disclosed herein but encompasses all variants, equivalents, modifications and combinations thereof which fall into the scope of the appended claims.

What is claimed is:

1. A method of generating a clip from a video displayed on a screen, comprising:
storing a set of videos in a database of a server, each video containing a sequence of pictures;
capturing an image of the screen displaying one of the videos of said set, with a capturing device;
transmitting the image, or a fingerprint derived from the image, from the capturing device to the server;
in the server, matching the image or fingerprint with at least one of the pictures of one of the videos in the database to determine a matching video and a timestamp of a matching picture in the matching video; and
extracting a clip from the matching video, the clip having a length shorter than that of said video and having a start and a stop time in a given relation to said timestamp.

2. The method of claim 1, wherein the screen is a television set, the video is broadcast to the television set and the server, and the step of storing comprises recording the broadcast video in the database.

3. The method of claim 1, wherein the screen is a computer, the video is a webcast to the computer, and the step of storing comprises providing the webcast video in the database.

4. The method of claim 1, wherein the capturing device is electronically connected to the screen for electronically capturing the image.

5. The method of claim 1, wherein the capturing device is a smartphone with a camera which is directed at the screen for optically capturing the image.

6. The method of claim 1, wherein the step of extracting comprises sending the extracted clip from the server to a remote device.

7. The method of claim 6, wherein the remote device is another server.

8. The method of claim 6, wherein the remote device is the capturing device.

9. The method of claim 1, wherein the step of extracting the clip comprises sending a playlist of uniform resource identifiers (URIs), each URI addressing a different one of subsequent groups of pictures (GOPs) within said clip, from the server to a remote device.

10. The method of claim 9, wherein the step of extracting the clip comprises playing the clip on a screen of the remote device by subsequently retrieving said GOPs from the database via the URIs of said playlist.

11. The method of claim 1, wherein the given relation is a time window delimited by said start and stop times and into which said timestamp falls.

12. The method of claim 1, wherein the step of extracting the clip comprises, before sending said playlist:
sending a subset of pictures, which are in different time relationship to said timestamp, together with times of said pictures within the clip, from the server to a remote device; and
displaying the subset of pictures on a screen of the remote device and selecting the times of two of the pictures of said subset as the start and stop times of the clip.

13. The method of claim 1, wherein the step of extracting the clip comprises, before sending said playlist:
sending a subset of pictures, which are in different time relationship to said timestamp, together with times of said pictures, from the server to the remote device;
displaying the subset of pictures on a screen of the remote device and selecting the times of two of the pictures of said subset as the start and stop times of the clip.

14. The method of claim 9, wherein the step of extracting the clip comprises, before sending said playlist:
sending a subset of pictures, which are in different time relationship to said timestamp, together with times of said pictures, from the server to the remote device;
displaying the subset of pictures on a screen of the remote device and selecting the times of two of the pictures of said subset as the start and stop times of the clip;
wherein the subset comprises one picture of each GOP.

15. The method of claim 1, wherein a time of capturing or transmitting the image is recorded and used for narrowing the matching of the image or fingerprint with the pictures of the videos.

16. A method of generating a clip from a video displayed on a screen, comprising:
storing a set of videos in a database of a server, each video containing a sequence of pictures;
capturing an image of the screen displaying one of the videos from said set, with a capturing device;
transmitting the image, or a fingerprint derived from the image, from the capturing device to the server;
in the server, matching the image or fingerprint with pictures of the videos in the database to determine a set of matching pictures and a set of timestamps of the matching pictures;
displaying the matching pictures on a screen of the capturing device and selecting one of the matching pictures; and
extracting a clip from that video which contains the selected matching picture, the clip having a length shorter than that of said video and having a start and a stop time in a given relation to the timestamp of the selected matching picture.

17. The method of claim 16, wherein the step of extracting the clip comprises
sending a playlist of uniform resource identifiers (URIs), each URI addressing a different one of subsequent groups of pictures (GOPs) within said clip, from the server to the capturing device; and
playing the clip on a screen of the capturing device by subsequently retrieving said GOPs from the database via the URIs of said playlist.

18. A server, configured to
store a set of videos in a database, each video containing a sequence of pictures,
receive an image, or a fingerprint derived from the image, from a capturing device, the image having been captured from a screen displaying one of the videos from said set,
match the image or fingerprint with at least one of the pictures of one of the videos in the database to determine a matching video and a timestamp of said matching picture in the matching video, and
extract a clip from the matching video, the clip having a length shorter than that of said video and having a start and a stop time in a given relation to said timestamp.

19. The server of claim 18, further configured to, when extracting the clip,
send a playlist of uniform resource identifiers (URIs), each URI addressing a different one of subsequent groups of pictures (GOPs) within said clip, from the server to a remote device.

20. A capturing device for generating a clip from a video displayed on a screen, comprising:
a communication interface for communicating with a server which stores a set of videos in a database, each video containing a sequence of pictures;
the capturing device being configured to
capture an image of the screen displaying one of the videos from said set,
transmit the image, or a fingerprint derived from the image, to the server, and
receive a clip from the server, the clip having been extracted from the video by matching the image or fingerprint with at least one of the pictures of one of the videos in the database to determine a matching video and a timestamp of said matching picture in the matching video, the clip having a length shorter than that of said video and having a start and a stop time in a given relation to said timestamp.

21. The capturing device according to claim 20, further configured to, for receiving the clip, first receive a playlist of uniform resource identifiers (URIs), each URI addressing a different one of subsequent groups of pictures (GOPs) within said clip, from the server, and then play the clip on a screen of the capturing device by subsequently retrieving said GOPs via the URIs of said playlist.

22. The capturing device of claim 21, wherein the capturing device is a smartphone with a camera configured to optically capture the image.
